(19) United States
(12) Patent Application Publication
(10) Pub. No.: US 2008/0028324 A1
(43) Pub. Date: Jan. 31, 2008

(54) MULTI-APPLICATON BULLETIN BOARD

(75) Inventor: Daryl David Coutts, Edmonton (CA)

Correspondence Address: BEYER WEAVER LLP, P.O. BOX 70250, OAKLAND, CA, 94612-0250, US

(73) Assignee: MARENGO INTELLECTUAL PROPERTY LTD., Edmonton (CA)

(21) Appl. No.: 11/836,297

(22) Filed: Aug. 9, 2007

Related U.S. Application Data
(63) Continuation-in-part of application No. 11/472,132, filed on Jun. 20, 2006.
(60) Provisional application No. 60/779,654, filed on Mar. 7, 2006.
(60) Provisional application No. 60/796,185, filed on May 1, 2006.
(60) Provisional application No. 60/801,395, filed on May 19, 2006.
(60) Provisional application No. 60/809,831, filed on Jun. 1, 2006.
(60) Provisional application No. 60/814,537, filed on Jun. 19, 2006.
(60) Provisional application No. 60/843,393, filed on Sep. 11, 2006.
(60) Provisional application No. 60/842,667, filed on Sep. 7, 2006.

(51) Int. Cl. G06F 3/00

(52) U.S. Cl. 715/752

(57) ABSTRACT

Methods and systems for receiving notifications from plural running computer programs and facilitating user interaction with the plural running computer programs are disclosed.

### CROSS REFERENCE TO RELATED APPLICATIONS

This application is a continuation-in-part of pending U.S. application Ser. No. 11/472,132, filed on Jun. 20, 2006, which claims the benefit of priority under 35 USC §119(e) to U.S. Provisional Application No. 60/779,654, filed on Mar. 7, 2006; U.S. Provisional Application No. 60/796,185, filed on May 1, 2006; U.S. Provisional Application No. 60/801,395, filed on May 19, 2006; U.S. Provisional Application No. 60/809,831, filed on Jun. 1, 2006; and U.S. Provisional Application No. 60/814,537, filed on Jun. 19, 2006; this application also claims the benefit of priority under 35 USC §119(e) to U.S. Provisional Application No. 60/843,393, filed on Sep. 11, 2006, and U.S. Provisional Application No. 60/842,667, filed on Sep. 7, 2006.

All of the above applications are incorporated herein by reference in their entirety for all purposes.

### TECHNICAL FIELD

This invention pertains to computerized methods and systems for displaying information on a display associated with a computing device.

### BACKGROUND OF THE INVENTION

Today, a computer user's display is a very busy environment. The typical user has many applications running on their computer. Email, word processing, spreadsheet, instant messaging, calendar, stock portfolio, newsreader, location and even process control. As a user is trying to complete a task, they are focused on one particular application, but the other applications continue to work in the background. These background applications can send notifications to the user's screen at any moment. A user often has to attend to this notification, simply to determine the notification contents. This takes the user away from the task they are focussed on. This is very intrusive. An example is when a user is working on a document in a word processor. They receive an instant message notification that is usually a flashing rectangle at the bottom of their screen and an accompanying audio herald. To determine the contents of the instant message, the user must click on the flashing rectangle at the bottom of the screen, which then expands to an instant messaging conversation window. The user then must minimize the conversation window and return to the word processor application. The instant message notification has notably disrupted the user's work in the word processor application.

Nawaz in U.S. Pat. No. 6,421,694, teaches the display of notifications in a ticker display pane similar to that illustrated in FIG. 1a. Ticker panes repeat notifications periodically to increase the chance that a user will see the notification, but unless the user is looking at the ticker pane when a particular notification goes by, they will miss it. Another drawback with ticker panes is that because they repeat notifications periodically, old notifications are sometimes displayed next to new notifications. This lack of time order, in notification display, makes review of historic notifications difficult.

Email and newsreader programs use notification balloons in the corner of the screen. These notifications are transitory. If a user is not looking at the corner of the screen at the moment of the notification's arrival, the user will miss the notification. If a user is away from their computer while at lunch, they will miss all the notification balloons. Users do not trust that they have seen all their required notification balloons so they resort to manually checking all their applications for fresh notifications. The user checks their email application for the email they are expecting, they check their phone program to see who has called, they check their portfolio program for value of their portfolio, they check their newsgroup program to see if someone has responded to their question. All of this checking takes a lot of effort. To go through this checking cycle a user must click on the email icon to switch to their email inbox, examine their inbox, then click on the phone icon to switch to their phone inbox, examine their phone inbox, then click on the portfolio icon to switch to their portfolio application, examine their portfolio, then click on the newsgroup icon to switch to their newsgroup inbox and so on.

What is needed is a system and method such that a computer user can monitor a large number of notifications in one place. The display of notifications must not be disruptive to the user's current task. The computer user must be able to act on notifications quickly, easily transitioning to the computer program associated with the notification. The notifications must persist so the computer user can review them at their convenience. The display of the historic notifications must facilitate rapid review by the user.

### BRIEF SUMMARY OF THE INVENTION

In one embodiment, a method of the invention is implemented in a first computer program running on a computing device. The first computer program can also be referred to as the Multi-application Bulletin Board computer program. The computing device is associated with a user.

The first computer program receives messages (notifications) from plural running computer programs. The messages are received in a non-polled manner, that is to say, the messages are received on an event driven basis without requiring a particular query by the first computer program. The plural running computer programs can be running on the same computing device as the first computer program or some of them can also be running on other computing devices. In addition, the messages are intended to be received by the first computer program.

Headlines are derived from the received messages and the headlines are integrated into a sequence of headlines. The sequence of headlines is displayed on a display associated with the computing device. The displaying of the sequence of headlines is such that headlines corresponding to more recently received messages are displayed below headlines corresponding to less recently received messages in the plane of the display. The order of the displayed sequence of headlines can also be reversed. The displayed sequence of headlines covers only a small area on the display, thus allowing the user to work in a particular computer program and still see notifications from background computer programs.

User input directed at the displayed sequence of headlines can cause a message to be posted back to one of the plural running computer programs. For example, if a user clicks on a headline corresponding to an instant message, a message can then be sent to an instant messaging program running on the computing device. The instant messaging program might then bring up a specific conversation window. Another example would be if a user clicks on a headline corresponding to a location notification, a message can then be sent to a location program. The location program might then display more detailed location information on a subject.

User input directed at the displayed sequence of headlines can also cause a computer program to be launched. An example of this would be if a user clicks on a headline corresponding to a word processor document, a word processing application can then be launched.

As messages (notifications) are received, headlines are added to the sequence of headlines and the displayed sequence of headlines is updated. This is an improvement over the prior art event viewer in FIG. 1B that only updates in response to user input. In addition, the displayed sequence of headlines can be made to go partially transparent after a period of time with no new headlines or without user interaction. This reduces the effective screen real estate. Also, if a user has been away from their computer for a lunch, upon their return, they can easily scroll the displayed sequence of headlines to review the headlines added during their absence.

Using the described systems and methods, a computer user does not have to look, click and maneuver through multiple screen areas while keeping on top of their instant messaging, process monitoring, location monitoring and emailing. Using the described system and methods, when a computer user returns to their desk, they can quickly check the displayed sequence of headlines for phone calls, instant messages, location notices or emails they have received during their absence from the computer.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1a shows a prior art ticker pane.

FIG. 1b illustrates a prior art event log.

FIG. 2 shows an exemplary block diagram of a system of the invention.

FIG. 3a shows an example of a headline.

FIG. 3b is an example of a message sent to the first computer program.

FIG. 3c is another example of a message sent to the first computer program.

FIG. 4a shows an array of received messages

FIG. 4b shows an example user interface.

FIG. 5a illustrates a method of the invention.

FIG. 5b illustrates another method of the invention.

FIG. 6 shows how the displayed sequence of headlines might appear on a display of a computing device.

FIG. 7 illustrates what can happen when a user clicks on a headline from a location program.

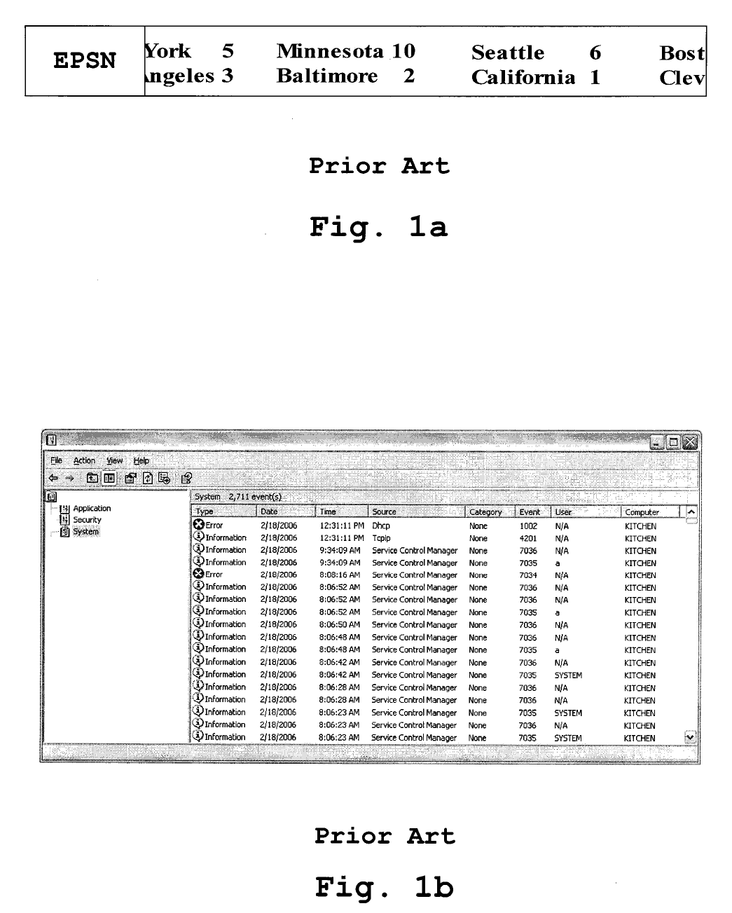

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

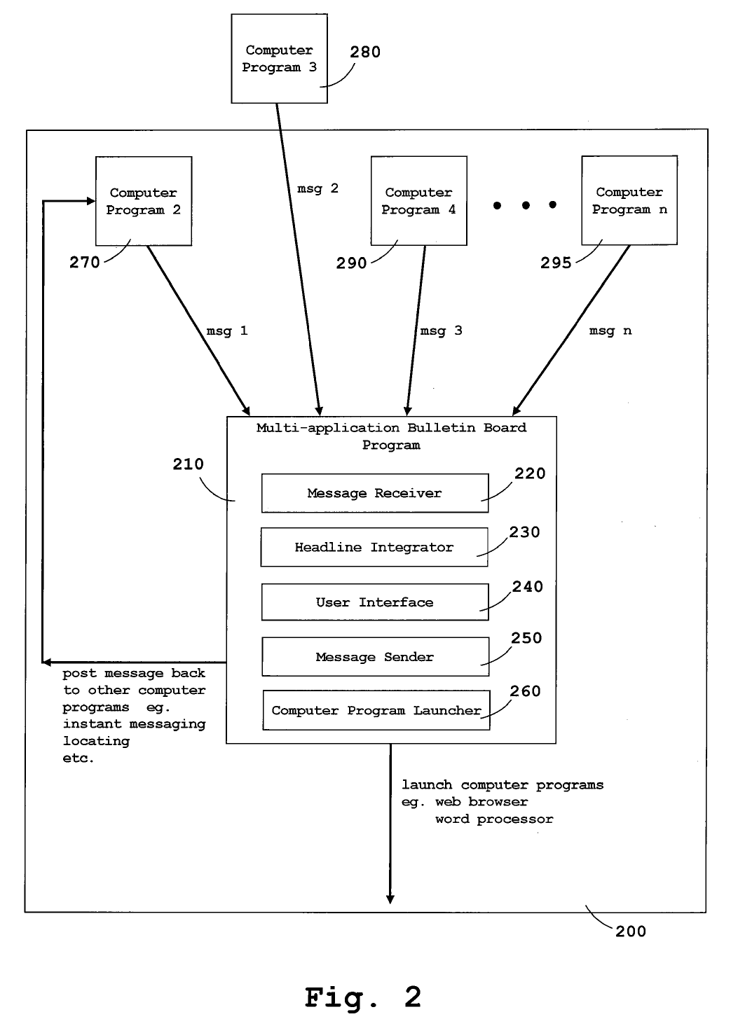

FIG. 2 is a block diagram of a system of the invention. 200 represents a computing device. The computing device is associated with a user. 200 can be any suitable type of computing device examples of which include: cellphone, handheld, PDA, desktop computer and notebook computer. 210 is a first computer program running on the computing device 200. The first computer program 210 can be any type of computer program such as an application or service or part of an operating system. The first computer program 210 comprises a message receiver 220, a headline integrator 230, a user interface 240, a message sender 250 and a computer program launcher 260. This illustration of the functional modules of 210 is an example only. Other combinations of functionalities within 210 are possible and fit within the invention.

270 is a second computer program running on the computing device 200. The second computer program 270 can send and receive messages with the first computer program 210. 280 is a third computer program running external to the computing device 200. 280 is shown only sending messages to the first computer program 210, but it could also receive messages from 210. 290 and 295 are fourth and “nth” computer programs running on the computing device 200, they are shown only sending messages to the first computer program 210 but they could also receive messages from the first computer program 210. In one embodiment, there are two or more computer programs sending messages to the first computer program.

Messages are sent to the first computer program 210 on an event driven basis, with the sending computer programs determining the events which cause a message to be sent as well as the timing of when a message is sent. This is described as the first computer program 210 receiving messages on an event driven basis.

There are many ways to send and receive messages between running computer programs, a few examples include TCP, HTTP, SOAP, DDE, COM and CORBA. In one embodiment, Hyper Text Transfer Protocol (HTTP) is used to send and receive messages between the running computer programs but certainly any other methodology, such as COM, could be used.

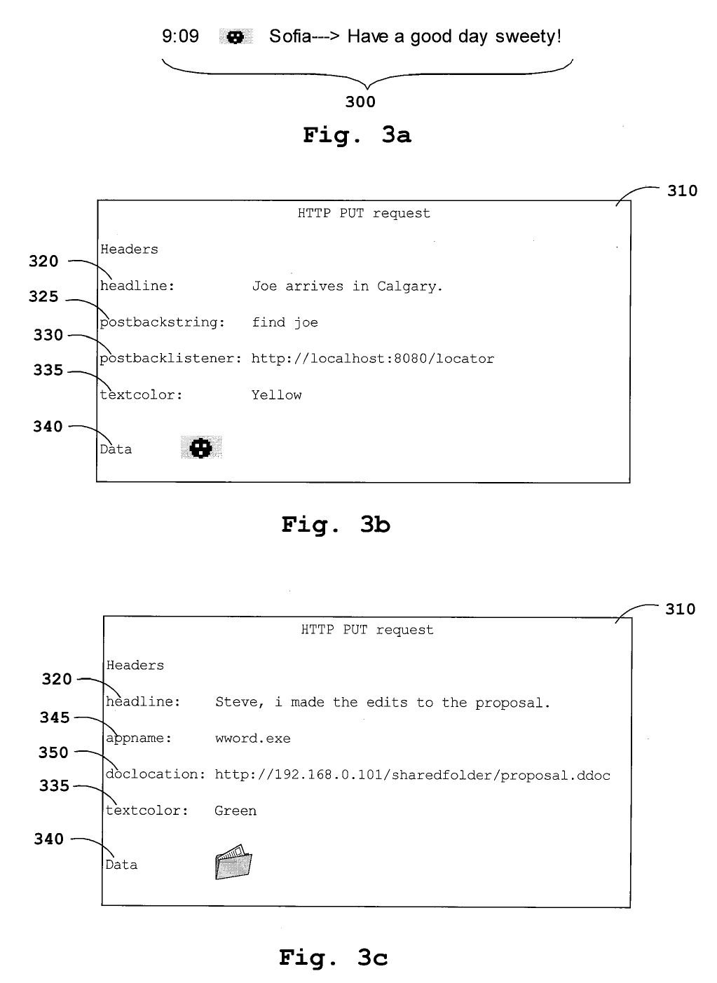

FIG. 3a illustrates one example of a headline 300. A headline 300 comprises at least one word. The time stamp and and icon shown as part of the headline 300 in FIG. 3a are optional. Also, other elements can be added to the headline 300 and it is still a headline 300. A headline 300 can have text that extends for several rows, depending on how it is displayed.

FIG. 3b is an example of a message 310 that might be sent from the second computer program 270 to the first computer program 210. In this example, the second computer program 270 is a location application (this is an example only, the second computer program 270 can be any type of computer program). The message 310 is sent as an HTTP PUT request. The HTTP headers are populated with the details of the message 310. 320 is a headline header that contains the characters of a headline associated with the message 310. 325 is a postbackstring header that contains a string that can be sent back to the second computer program 270. 330 is a postbacklistener header that contains the address where the postbackstring can be sent. 335 is the textcolor header that contains a possible color for use in the display of the headline 300 associated with the message 310. 340 is data in the message which in this case is the binary data of an icon.

FIG. 3c is an example of a message 310 that might be sent from the third computer program 280. 345 is a appname header which contains the name of a computer program that can be launched. 350 is a doclocation header which contains a parameter that can be used when launching the computer program indicated by the appname header 345.

FIG. 3b and FIG. 3c are examples of messages 310 that can be received by the first computer program 210. These examples are using HTTP PUT requests. Messages 310 might be informational only and not contain postback strings or computer program names. Messages 310 can be in a format different than described in these examples. Messages 310 can have content different that described in these examples. Messages 310 can be received using communication methodologies different than HTTP, one possible alternative would be to use COM to send messages 310 from the second computer program 270 to the first computer program 210. In addition, the messages 310 received by the first computer program 210 are primarily intended for the first computer program 210.

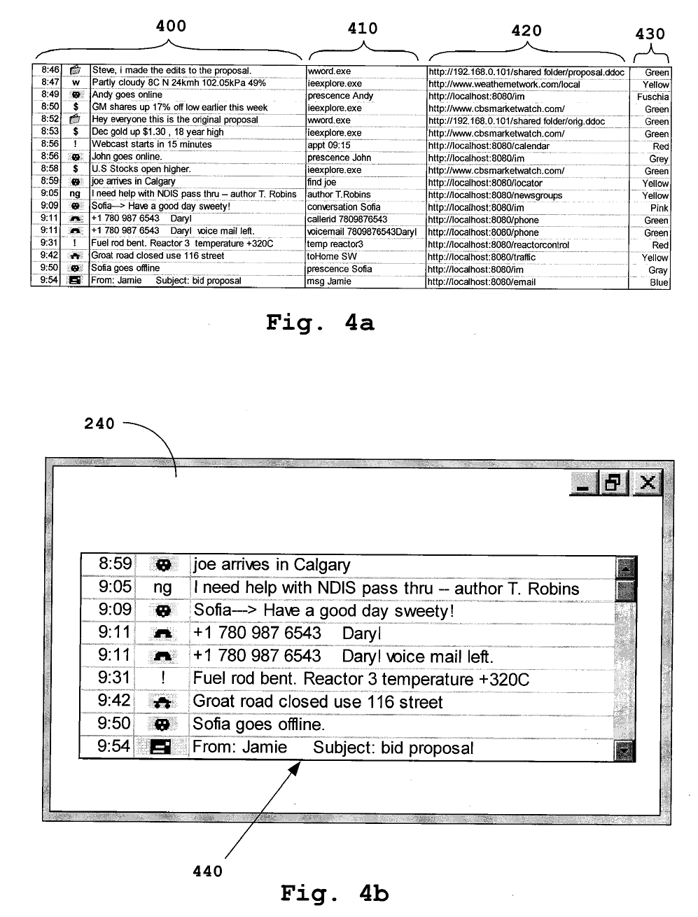

FIG. 4a is an example of an array of messages 310 received by a first computer program 210. Each row in the array corresponds to a received message 310. Column 400 holds the headlines 300 of the received messages 310. Column 410 holds either the postback string or the name of the computer program to launch. Column 420 holds the address of where to send the postback string or else a parameter to be used when launching a computer program. Column 430 holds the color to use when displaying the headline 300.

FIG. 4b is an example of a user interface 240. 440 is a sequence of headlines 300. In one embodiment, the sequence of headlines is displayed using a datagridview control in a window. Other ways of displaying the sequence of headlines are possible and fit within the scope of the invention.

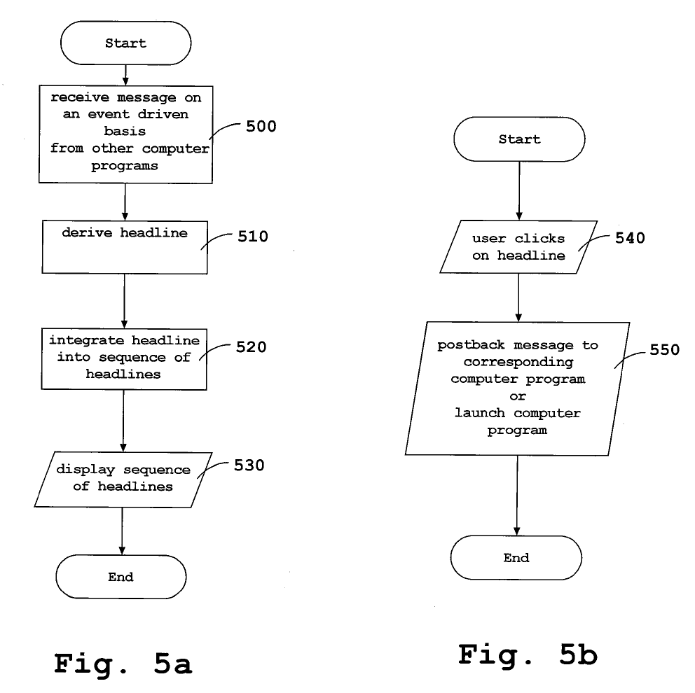

FIG. 5a is a flowchart of a method in the preferred embodiment. In step 500, the first computer program 210 receives messages 310 on an event driven basis from at least two other computer programs. As indicated earlier the messages 310 can be received via HTTP, or a COM interface or any other way of exchanging messages between computer programs. If the messages 310 are received via HTTP, the message receiver 220 can comprise an HTTP listener.

In step 510, a headline 300 is derived from the received message 310. This step is usually performed in the message receiver 220, but it can be performed in another functional block of the first computer program 210. Deriving a headline 300 comprises obtaining summary text that corresponds to the received message 310. Examples of deriving a headline 300 can include parsing an email message for the subject line or extracting a portion of text from an instant message. Another example of deriving a headline 300 can comprise selecting a certain field in a received message. Many other examples of deriving a headline 300 are possible.

In step 520, the derived headline 300 is integrated into a sequence of headlines 440. This step is usually performed in the headline integrator 230, but it can be performed in another functional block of the first computer program. The array in FIG. 4a can be a result of the headline integration in this step. In one embodiment, step 520 gets executed by a function call from the message receiver 220. Also, in one embodiment the message receiver 220 is running on a different thread than the headline integrator 230.

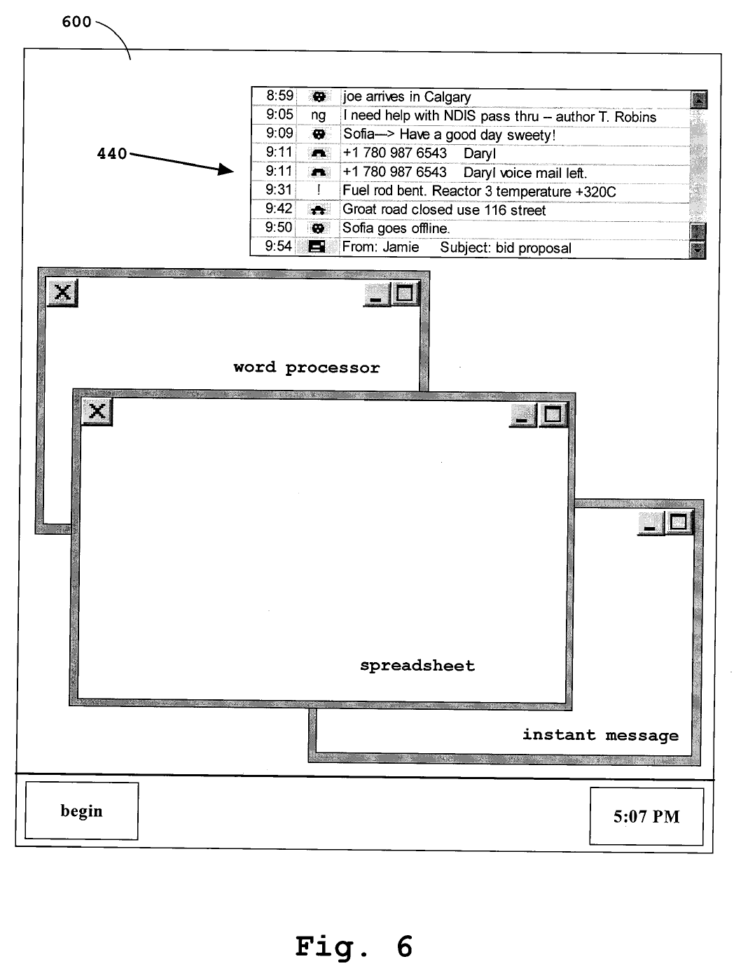

In step 530, the sequence of headlines 440 is displayed as part of a user interface 240. FIG. 6 shows an example of displaying the sequence of headlines 440 on a display 600 associated with the computing device 200. Note that when the sequence of headlines 440 is displayed, headlines 300 corresponding to more recently received messages 310 are displayed below headlines 300 corresponding to less recently received messages 310 in the plane of the display 600. This order can be reversed, such that when the sequence of headlines 440 is displayed, headlines 300 corresponding to more recently received messages 310 are displayed above headlines 300 corresponding to less recently received messages 310, in the plane of the display 600.

After a new message 310 is received by the first computer program 210, the displayed sequence of headlines 440 is adjusted to show the most recent headlines 300. Also, the most recent headline 300 can be displayed in reverse video for ten seconds. The displayed sequence of headlines 440 is substantially static except when a new message 310 is received or when user input directed at the displayed sequence of headlines 440 is detected. Further, the displayed sequence of headlines 440 can be made to become substantially transparent after ten seconds of no user input or no new messages 310. When the user “mouseovers” the nearly transparent shadow of the displayed sequence of headlines 440, the displayed sequence of headlines becomes fully visible once again. Similarly, when a new message 310 is received, the displayed sequence of headlines 440 is made fully visible.

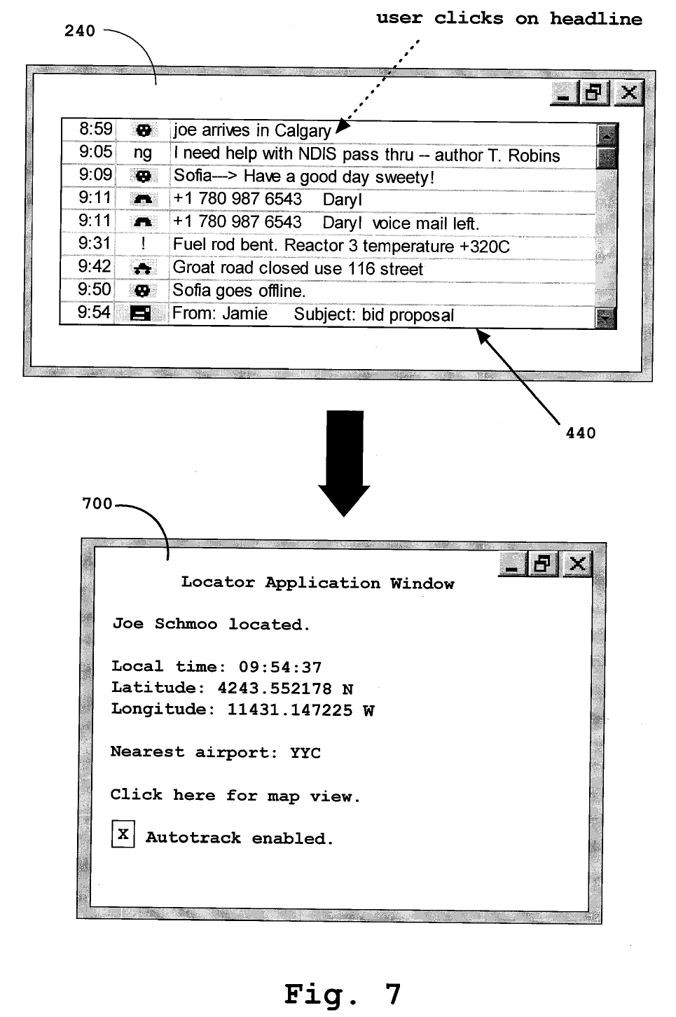

FIG. 5b is a flowchart of another method in the preferred embodiment. In step 540, the displayed sequence of headlines 440 is monitored for user input. Single click, double click, finger tap, stylus tap, double tap or any other similar action is a user input. When a user input is detected in step 540, then step 550 is executed. In step 550 it is determined which particular headline 300 in the displayed sequence of headlines 440 the user has directed input at. Further, a message can be sent from the first computer program 210 to the second computer program 270 in response to the user action. This is illustrated by example in FIG. 7. In FIG. 7, the user has clicked on a headline 300 derived from a message 310 sent by the second computer program 270. In this example, the second computer program 270 is a location program. After the second computer program 270 receives the postback message, it can initiate its own actions. In this example, the the second computer program 270 displays the window 700.

Additionally, in step 550, instead of sending a postback message, a computer program can be launched, such as a word processor or internet browser.

Step 550 can comprise the additional step of displaying an interim user interface element that requires another indication from a user before a postback message is sent to the second computer program 270 or another computer program is launched.

This detailed description of the invention is illustrative only, many other ways of implementing the invention are possible. As discussed earlier, instead of using HTTP to send messages to the first computer program 210, messages 310 could be sent using COM or by any of many other ways to communicate between running computer programs. The user interface could be implemented using textboxes instead of a datagrid control. Many other modifications are possible without departing from the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

What is claimed is:

1. A method implemented by a first computer program running on a computing device associated with a user, the method comprising:
receiving messages on an event driven basis, the messages originating from plural computer programs other that the first computer program and the messages intended for the first computer program;
integrating headlines corresponding to the received messages into a sequence of headlines;
displaying the sequence of headlines on a display associated with the computing device, such that headlines corresponding to more recently received messages are displayed one of above and below headlines corresponding to less recently received messages in the plane of the display; and
responding to user input directed at the displayed sequence of headlines by one selected from the list of sending a message to a second computer program and launching a third computer program.

2. The method of claim 1 wherein responding to user input directed at the displayed sequence of headlines comprises displaying an interim user interface element and responding to user input directed at the interim user interface element by one selected from the list of sending a message to the second computer program, launching the third computer program and sending a message to the third computer program.

3. The method of claim 1 where the user input is one selected from the list of: single click, double click, finger tap, stylus tap and stylus double tap.

4. The method of claim 1 where one or more of the plural computer programs is running external to the computing device.

5. The method of claim 1 where when a headline is first displayed in the sequence of headlines it is displayed in reverse video for a period of time and is displayed in non-reverse video thereafter.

6. The method of claim 1 where the displayed sequence of headlines becomes partially transparent upon occurrence of a specified condition.

7. The method of claim 6 where the specified condition is the passage of a specified period of time with no messages received and with no user input received.

8. A system for facilitating user interaction with plural running computer programs, the plural running computer programs external to the system, the system implemented on a computing device associated with the user, comprising:
a message receiving means, configured to receive messages on an event driven basis from the plural running computer programs and derive headlines from the messages, where the messages are intended to be received by the system;
a user interface means for accepting headlines from the message receiving means, integrating the headlines into a sequence of headlines, displaying the sequence of headlines on a display associated with the computing device, the displaying such that headlines corresponding to more recently received messages are displayed one of above and below less recently received messages and responding to user input directed at the displayed sequence of headlines ; and
a message sending means for sending messages to plural running computer programs.

9. The system of 8 further comprising a program launching means.
